(19) United States
(12) Patent Application Publication
(10) Pub. No.: US 2025/0154774 A1
(43) Pub. Date: May 15, 2025

(54) MORTARLESS BRICK

(71) Applicant: Adel K. AlSubaih, Kaifan (KW)

(72) Inventor: Adel K. AlSubaih, Kaifan (KW)

(21) Appl. No.: 18/507,682

(22) Filed: Nov. 13, 2023

(51) Int. Cl. E04F 13/08; B28B 3/06; E04F 13/14

(52) U.S. Cl. CPC E04F 13/085; E04F 13/0894; E04F 13/14; B28B 3/06; E04F 2201/0107; E04F 2201/023; E04F 2201/043

(57) ABSTRACT

This document describes a thin mortarless cladding brick made using a high efficiency production method with low material cost and low cost workmanship to install. The brick is made by a pavement press machine, produced with a longitudinal tongue and groove with one side slot and dent, made by a press die, for a mounting bracket. Bricks will interlock with each other on top and bottom and fixed to a raw wall using the proper mounting brackets with adjustable screw.

### BACKGROUND

Decorative masonry façades are often used in place of load-bearing brick for lower cost and ease of construction. Prior art decorative masonry façades are known in the patent literature.

US20100031592 describes composite cladding panel comprising an internal skin and an external skin with insulation material there between, one of the skins having a plurality of tongue and mortise blocks mounted directly to the panel by a mounting means to form a cladding. While it uses interlocking mortarless cladding, it is thick and requires a flat substrate wall.

US20020056237 describes a wall structure comprising a plurality of columns of preformed, lightweight, stacked blocks, with the columns of blocks connected to each other by a plurality of elongated, vertically oriented, support beams. This can be very expensive in material cost, requires a flat substrate wall, and requires a large amount of labor.

U.S. Pat. Nos. 6,393,791 and 6,442,913 describe a freestanding wall constructed by erecting at least two upright supports. The upright supports are either posts or columns. Upper and lower horizontal structure members are fastened to the upright supports. Cladding is attached to at least the front and optionally the back of each vertical intermediate framing member to conceal each vertical intermediate framing member. This also requires a flat substrate wall, and is expensive with regard to workmanship.

US20220243481 describes a frame for retaining one or more masonry slips, the one or more masonry slips each having two slots formed on two sides thereof, so as to thereby hold the one or more masonry slips within the elongate channel when said one or more masonry slips are present. This requires a flat substrate wall, and has a high material cost.

The prior art requires flat wall and involve extensive metal or plastic mounting profiles. Thus, improved solutions are needed.

### SUMMARY OF INVENTION

Therefore, the present invention provides an inexpensive cladding in material and workmanship. It is thin and made by cost effective press, it does not require flat even wall and can be mounted with minimal brackets. The brick veneer is made on a pavement press machine; it pressed on its side, vertically in the mold, in singles or made in multiple and split after curing. The brick designed for walls is built using raw blocks without plastering and has an adjustable screw and bracket to mount to an uneven wall.

According to an aspect of the present invention, there is provided a brick cladding, comprising: a front surface; an upper tongue; a bottom groove; and a side slot, wherein the upper tongue is configured to receive a bottom groove of an adjacent cladding above; and the bottom groove is configured to receive an upper tongue of an adjacent cladding below.

According to another aspect of the present invention, there is provided mounting for brick cladding, comprising a mounting bracket configured to insert in a side slot of the brick cladding. The mounting bracket can be in an L shape, a T shape, or a Z shape.

According to yet another aspect of the present invention, there is provided a method of manufacturing brick cladding, comprising using multiple dies to press the brick of the cladding in a mold against a pallet and shape a side slot and dent.

### BRIEF DESCRIPTION OF THE DRAWINGS

FIG. 1: Mortarless cladding brick showing the press die side with mounting slot.

FIG. 2: Mortarless cladding brick showing the flat pallet side.

FIG. 3: Mortarless cladding brick showing the back.

FIG. 4: Wall built using mortarless cladding bricks.

FIG. 5: Interlock clearance allowing for mold cavity wear and for T mounting bracket.

FIG. 6: Mounting brackets of different orientations, including but not limited to, Z, L and T shapes, and how it will fit with the cladding bricks.

FIG. 7: Manual cut needed to mount T shaped mounting bracket.

FIG. 8: Pressing orientation showing single brick or double bricks with splitable face or back.

FIG. 9: Pallet flat side showing the splitting line.

FIG. 10 Multi cavity mold and die shown with the pallet.

FIG. 11 Close-up view of the press die,

FIG. 12 close-up view of the multi-cavity mold with section view to show inside separator.

### DETAILED DESCRIPTION

Brickwork is one of the finest building material for cladding and facade; however, it is expensive in material and workmanship. This patent presents a cost effective alternative, but still appears as brick façade. It uses less material, produced in mass production pavement press, and it is fast and easy to install without mortar with easy alignment and mounting to the substrate wall. The cost of the brick reduced by making it thin, hence less material, and producing using a cost effective mass production pavement press machine. Workmanship reduced by having interlocking feature and easy adjustable bracket and screw mounting without the need of pre-plastering. Those features together will make a cost effective solution without losing the classic look.

The invention is a mortarless thin interlocking cladding bricks designed to be made using high production, cost effective interlock pavement press with means of fasting to the substrate wall. It consists of tongue and groove along the direction of pressing with slot in one side to insert mounting bracket to screw fasten it to a substrate wall with the ability to adjust and align. Depending on the height of the brick, it can be produced in singles or multiples and be split post-curing. It is designed to be cost effective in material and workmanship.

In some parts of the world, building is constructed using concrete column, beams and floor slap, and then external and internal walls built using raw blocks, which requires cladding in the exterior and plastering in the interior. In many cases the external wall are not perfectly vertical nor flat which needs to be plastered before applying selected cladding material.

Brick cladding is one of the best cladding options for its classic look and long life. However, it is expensive due the cost of the bricks and the cost of workmanship to install.

A pavement tiles press is a machine used to mass-produce concrete or cement tiles that commonly used for paving walkways, driveways, and outdoor and indoor spaces. It is the most cost efficient tile production machine. It typically consists of a few main components:
1. Hopper or Feeder: This is where a semi-dry mixture of concrete or cement, along with aggregates like stones and sand, are loaded. The hopper feeds the mixture into the press for further processing.
2. Pressing Mechanism: The pressing mechanism is responsible for compacting the semi-dry mixture into the desired shape and thickness. It applies pressure to the mixture to create uniform tiles. This mechanism may use hydraulic, mechanical, or pneumatic systems to generate the required compaction, with or without vibration.
3. Mold or Die: A mold block consists of many mold cavities to define the tiles outer profile. A press block consists of set of dies well aligned with the cavities to shape the top texture of the tile. Mold cavities and dies together determines the final design, texture, and size of the pavement tiles. Note her the limitations of the shape to be in profile format with top shape made by the press dies that can be pushed out of the mold without damage. The concrete semi-dry mixture poured into the mold cavities, and the pressing mechanism applies pressure to shape and compact it into the designed profile shape, thickness and texture.
4. Ejection System: Once the tiles pressed and formed, an ejection system used to release the tiles from the mold cavities. This can be manual or automated, depending on the design of the press. In high production presses, the tiles pressed directly on draw table or directly on the pallet that will eventually receive the green tiles for stacking and curing.

The entire process of the pavement tiles press involves loading the semi-dry mixture, pressing it to the desired shape and thickness into a mold cavity and dies, vibrating and compacting, and finally ejecting the formed tiles into a pallet for curing. It is an efficient and precise method for producing high quality and high quantity pavement tiles.

In this patent, the cladding brick designed to be produced in high production pavement press utilizing its capability to make mortarless thin cladding bricks with means of fastening to the substrate wall. Producing it on pavement press, will impose restrictions and limitations on the brick profile, which should be taken into consideration.

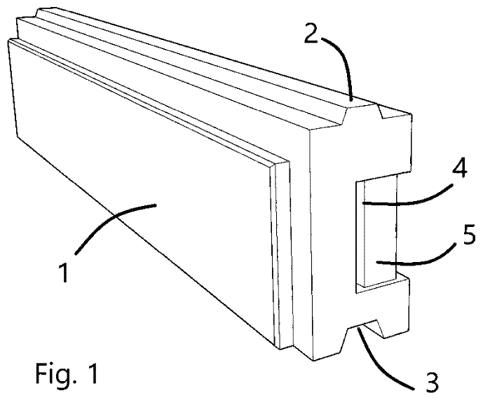

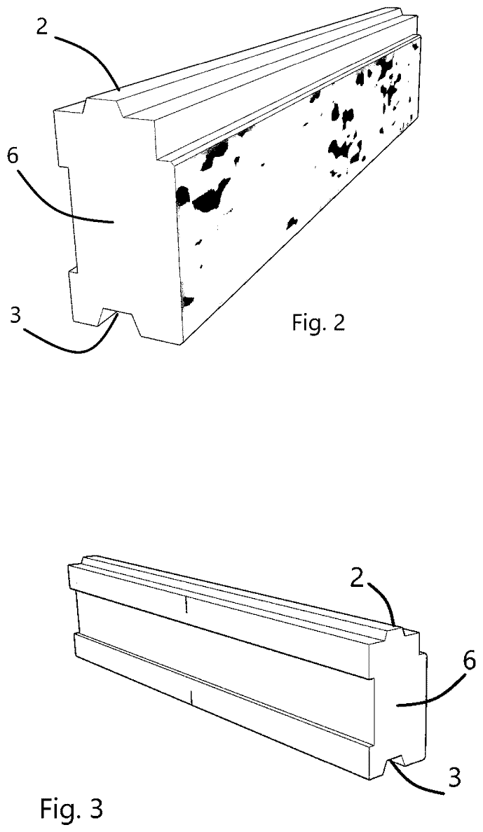

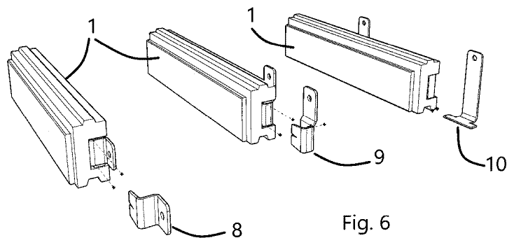

The brick 1 in FIG. 1,2,3, made according to the desired dimensions and face design with upper tongue 2 and bottom groove 3 along its length with side slot 4 and dent 5 made with die stamp of the press while the other side is flat 6 against the pallet. The tongue 2 and groove 3 has sufficient clearance 7, FIG. 5, allowing for mold wearing and for the T bracket.

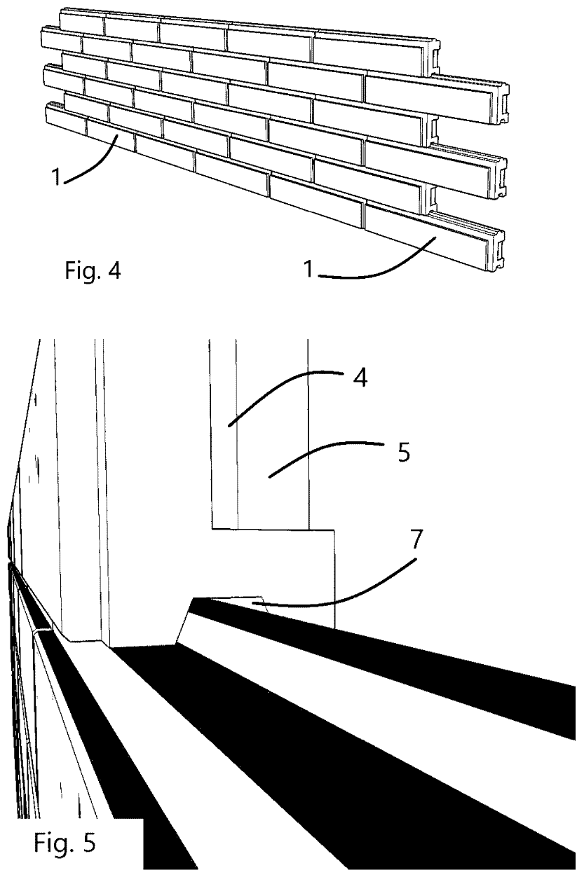

FIG. 4, show how the wall will look like when built without mortar. It can be produced with brick spaces or with longitudinal chamfer or flat. The face also can have longitudinal texture or can be split face.

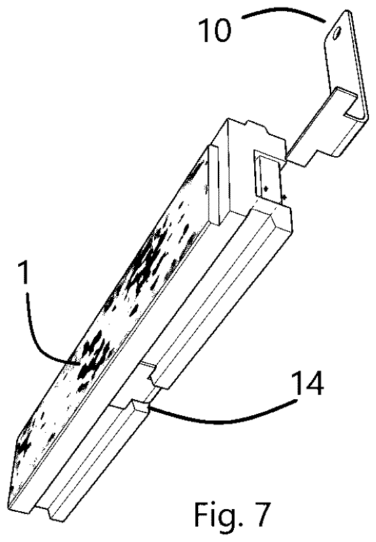

Mounting brackets FIG. 6 can be of any desired shape; such as Z shape 8 or L shape 9 or T shape 10. Brackets are not needed for every brick, as it will mount the cladding well if used one for every several bricks depending of the substrate wall and the type of back fill. The T shape bracket 10 will need a manual cut 14 in the back of the groove, FIG. 7, with enough clearance 7 between the interlocking bricks.

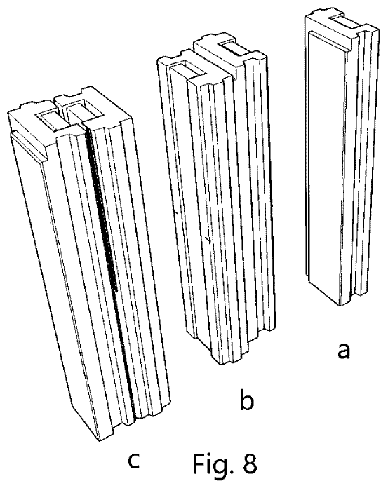

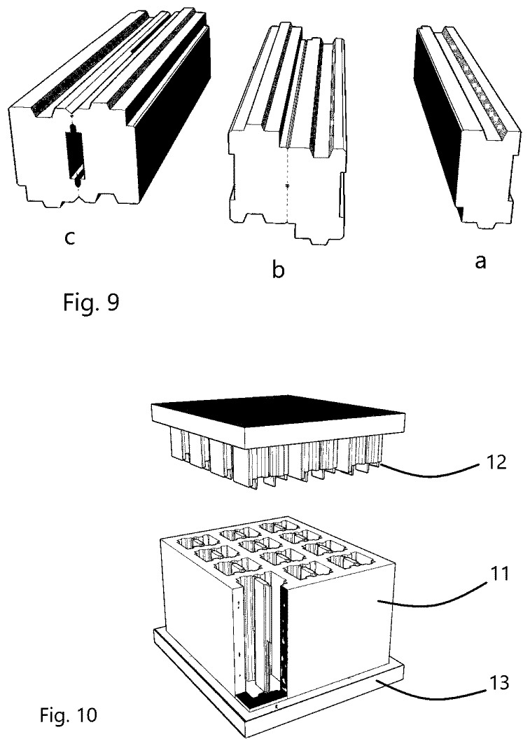

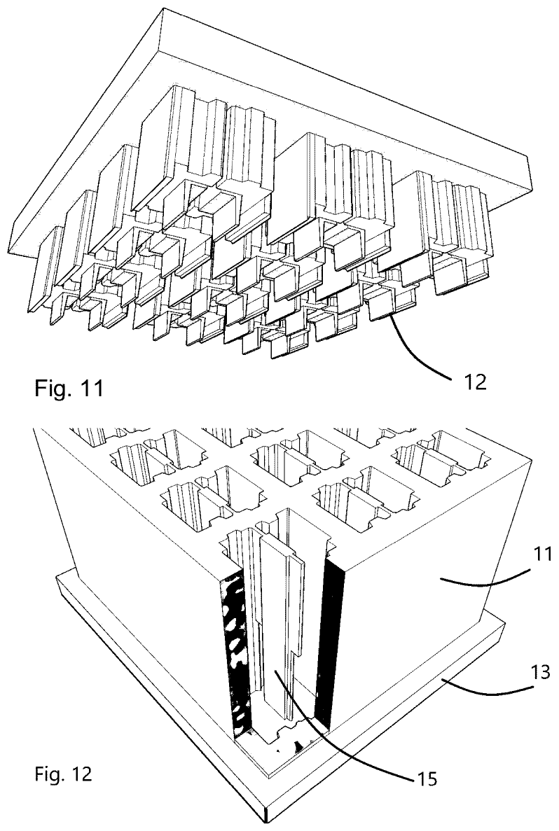

Depending on the height of the product and stability of the handling system, bricks can be produced in singles, FIG. 8a or for more stable in double, FIG. 8b,c and be split after curing. Double brick with attachment in the back c can be split on site to produce two bricks with flat face. Double brick with attachment in the face b can be split to produce two bricks with stone texture face. FIG. 9 showing the split line from the pallet side.

The mold can be of multiple cavity, 11, FIG. 10, with multiple dies 12 pressing the brick and shaping the side slot and dent, pressing against the pallet 13. Dies 12 also eject the green brick out of the mold 11 into the pallet 13 which then be taken to curing chamber.

FIG. 12 is a close-up view of the multi-cavity mold with section view to show inside separator which shows separator 15 in mold section.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A brick cladding, comprising:
a front surface;
an upper tongue;
a bottom groove; and
a side slot,
wherein the upper tongue is configured to receive a bottom groove of an adjacent cladding above; and
the bottom groove is configured to receive an upper tongue of an adjacent cladding below.

2. The brick cladding of claim 1, wherein the side slot is configured to receive a mounting bracket.

3. The brick cladding of claim 1, wherein one mounting bracket is provided for every two cladding sections or more.

4. A mounting for brick cladding, comprising a mounting bracket configured to insert in a side slot of the brick cladding.

5. The mounting bracket of claim 4, wherein the mounting bracket is in a Z shape.

6. The mounting bracket of claim 4, wherein the mounting bracket is in an L shape.

7. The mounting bracket of claim 4, wherein the mounting bracket is in a T shape.

8. A method of manufacturing brick cladding, comprising using multiple dies to press the brick of the cladding in a mold against a pallet and shape a side slot and dent.

9. The method of claim 8, wherein the bricks are produced in singles.

10. The method of claim 8, wherein the bricks are produced in doubles for texture and making the foot print larger to be stable during handling.

11. The method of claim 10, wherein the bricks are split after curing.

12. The method of claim 8, wherein the bricks are product in multiple cavity.

13. The method of claim 8, further comprising ejecting the brick out of the mold into the pallet.

14. The method of claim 8, further comprising curing the cladding in a curing chamber.
